(19) United States
(12) Patent Application Publication
(10) Pub. No.: US 2010/0072072 A1
(43) Pub. Date: Mar. 25, 2010

(54) METHOD FOR THE RESTORATION OF A METALLIC COATING

(76) Inventors: Daniel Beckel, Wettingen (CH); Alexander Stankowski, Siggenthal-Station (CH); Daniel Reitz, Suhr (CH)

Correspondence Address: CERMAK KENEALY VAIDYA & NAKAJIMA LLP, 515 E. BRADDOCK RD, ALEXANDRIA, VA, 22314, US

(21) Appl. No.: 12/258,730

(22) Filed: Oct. 27, 2008

(30) Foreign Application Priority Data
Sep. 19, 2008 (EP) 08164681.2

(51) Int. Cl. C25D 5/02; B05D 5/00; C23C 4/06; B05D 7/14; C25F 3/02; C25D 5/34

(52) U.S. Cl. 205/118; 427/140; 427/455; 427/142; 205/644; 205/205; 205/219

(57) ABSTRACT

A method for restoration of a metallic coating (2) of a component (1), in which the coating includes a consumed portion (3, 4), includes

a. identifying the consumed portion (3, 4) as a function of the location on the component (1);
b. removing at least the consumed portion (3, 4) as a function of the location as identified in step a.;
c. applying new metallic coating (7) in a manner at least compensating for the coating removed in step b.; and
d. optionally verifying the quality of the restored metallic coating (2).

This application claims priority under 35 U.S.C. §119 to European application no. 08164681.2, filed 19 Sep. 2008, the entirety of which is incorporated by reference herein.

### BACKGROUND

1. Field of Endeavor

The present invention relates to the field of restoration of coated components of gas turbines, wherein the coatings include metallic coatings, and coating systems having at least a metallic coating, and wherein the coating that has to be restored includes a consumed portion. Throughout this specification the term metallic coating is used to generically describe metallic overlays, diffusion, and bond coatings.

2. Brief Description of the Related Art

Components such as turbine blades, vanes or structural parts operating in the hot gas path environment of a gas turbine engine can be subjected to high temperature, thermal cycling as well as degrading environments that promote oxidization and corrosion. In order to prevent or at least minimise oxidation and hot gas corrosion, it is common practice to apply a metallic coating or a combination of a metallic and a ceramic coating to the surface of the component, wherein the ceramic coating is a thermal barrier coating (TBC). The coatings can result in improved efficiency of the engine by enabling an increase in operating temperatures or, alternatively, a reduction in cooling air consumption.

Protective coatings can include a metallic coating applied to the component surface, to form a bond coating, or inner metallic coating, and an insulating ceramic outer layer, applied directly onto the bond coat, to form a TBC outer coating that can be made of zirconia stabilized with yttria. Alternatively, only metallic coatings can be formed, also in combinations with other coatings.

Ni, Al, and Cr, or Co, Ni, Al, and Cr, or Pt and Al based alloys can be used to form metallic coatings. Coatings can also take the form of MAl, wherein M is at least one element selected from Fe, Ni, and Co and includes, for example, MAl, MAZY, MCrAl, and MCrAlY. Another class of coatings are diffused aluminide coatings. The coatings may be formed of one or more layers distinguished by their chemical or physical properties, and, e.g., one layer of the metallic coating system is of MCrAI(X) type, where M is an element selected from the group containing Ni, Co, Fe, and combinations thereof; and X is an element selected from the group consisting of Y, Ta, Si, Hf, Ti, Zr, B, C, and combinations thereof. Another possibility is that one layer of the metallic coating can be an aluminide, noble-metal-aluminide, noble metal-nickel-aluminide, or the like.

The metallic coatings can be applied by vapour deposition, such as PVD, CVD, or thermal spray methods, atmospheric spray methods, sputtering, cathodic arc, and electron beam, as well as by plasma spray processes. Coating composition, microstructure and thickness are controlled by processing parameters. Diffused aluminide coatings have been applied by a variety of methods including, as used in the art, pack cementation, above the pack, vapour phase, chemical vapour deposition, and slurry coating processes. The thickness and composition of the end product coating can be controlled by varying coating time, coating temperature, and activity of the coating materials and process. Incorporating such elements as Pt, Rh, Pd, Cr, Si, Hf, Zr, and/or Y often enhances the performance of such coatings. With either type of metallic coating, elements of the coating interdiffuse with an article substrate during processing or operation or both, yielding a diffusion zone between the metallic coating and the underlying article substrate. The diffusion zone is considered to be part of the metallic coating. As used herein, the term inner metallic coating is intended to mean at least a portion of the remaining inner metallic coating and such diffusion zone between the metallic coating and the underlying article substrate.

For gas turbine engine applications, the materials and processing methods chosen for the coating system are selected to provide resistance to spallation of the ceramic outer layer during thermal cycling of the engine, as well as resistance to the oxidizing and corrosive environment in the case of a spallation event. During normal engine operation after time, the coatings, including the metallic coating and the ceramic outer layer, will degrade (preferably or particularly) in certain surface areas most subject to operating conditions and environmental stress, the degradation may also depend on the local quality of the coating at these locations. The metallic coating has been observed to be consumed by thermally grown oxides (degradation), consumption of reservoir phases, and it has been observed to interdiffuse with a component substrate in such surface areas during operation to the extent that its protective ability has been reduced below an acceptable level, necessitating the removal and reapplication of a protective coating. Therefore, throughout this specification the term ‘consumed portion of the metallic coating’ is used to describe that part of the metallic coating that is consumed by the above-described processes, including degradation, depletion (consumption of reservoir phases), and interdiffusion. The consumed portion represents the amount of the metallic coating that has been consumed.

A current practice in such repair is to remove the entire coating including the metallic coating, optionally along with its zone of diffusion with the component substrate, and the outer ceramic layer. This usually leads to a reduction of the wall thickness. After any required repair of the component structure, the entire coating, including a new metallic coating and a new outer ceramic coating, is reapplied. However, that type of coating system removal, in which the metallic coating is removed, will lead to thinning of component walls and reduce the number of possible repairs of the component, which is an undesirable cost factor. Furthermore, the complete removal increases throughput time for the repair process.

Stripping techniques disclosed in the prior art are not fully satisfactory, insofar as normally the entire coating is removed before a new coating can be applied, irrespective if the entire coating was consumed or not, or if the coating degradation was inhomogeneously distributed over the component surface. This is expensive and bears the risk of reducing the wall thickness of the underlying base material, since the base material is exposed to the abrasive treatment or aggressive stripping media prior to, subsequent or combined with mechanical treatment. Furthermore, reapplying the entire coating thickness is also more expensive and requires more time than replacing only the consumed portion of the coating.

U.S. Pat. Nos. 4,339,282 and 4,944,807, for example, disclose specific etching baths into which the component of which the coating is to be removed can be immersed. In both cases the aim is to remove the full coating structure of the whole component in order to apply a new coating afterwards.

U.S. Pat. No. 4,894,130 discloses a method for removal of such coatings in which the cleaned and activated component is immersed into an electrolyte bath and removal of the full coating layer takes place by applying an electric potential between the component and a cathode.

Another approach, disclosed in the prior art, involves local repair of coatings. U.S. Pat. No. 6,042,880, for example, discloses a method for complete removal of the ceramic TBC layer in local areas only in a manner such that the bond coat layer, i.e., the metallic coating layer is essentially not affected by the removal process and therefore does not have to be completely reconstituted. Another method is disclosed in EP 0713957, where the entire coating structure is completely removed from certain areas, such that the actual component material is uncovered and subsequently in these areas a new coating is built up.

This is appropriate if the coating is only deteriorated in a discrete location.

However, in general the metallic coating on the entire component surface is affected to some degree, since the entire component surface is exposed to the hot gas during operation of the gas turbine. Consequently, even when an inhomogeneous distribution of coating deterioration is present, the coating is consumed to some degree on the entire surface, but not within the entire thickness.

Therefore, a technique, which is able to restore the consumed portion of the coating, over the entire coated area, would be of great benefit.

The prior art can lack the following features:
A simple and cheap method to determine the thickness (e.g., amount) of consumed portions of the coating, that require replacement;
A method for removing the coating, that can be controlled to such an extent that only the consumed portion of the coating is removed and the underlying substrate is not affected. This decreases the number of potential restoration processes.
A means of assessing the overall coating quality after restoration of the coating with undamaged inner coatings.

A combination of these three points is necessary for successful and economic application of customized coating restoration.

### SUMMARY

One of numerous aspects of the present invention includes an improved, simple, and cheap method for the restoration of consumed portions of coatings of the above type, applied to metallic components, for example of gas turbines or combustion chambers. In particular, this aspect relates to outer coating restoration for components with undamaged inner coatings.

Another aspect correspondingly provides the following method for restoration of a consumed portion of a metallic coating or a metallic coating system of a component, comprising the steps of:

a. identifying the consumed portion of the metallic coating as a function of the location on the component;

b. removing at least the consumed portion as a function of the location on the component as identified in step a.;

c. applying new metallic coating in a manner compensating for removed metallic coating material,

d. optionally verifying the quality of the restored coating.

Yet another aspect of the present invention includes in a targeted manner, in a first step, of determining in detail where the metallic coating is consumed, to what extent it is consumed, and if it needs to be replaced. Correspondingly in this first step the component to be restored is analysed and the amount of consumed metallic coating which is to be replaced (the thickness thereof) is determined, preferably in a spatially resolved manner, i.e., in a manner such that the consumed portions of the metallic coating are identified as a function of the location on the component.

In a second step, again in a targeted manner, based on the collected data in the first step, the consumed portion of the metallic coating is removed, only in defined areas and only to the extent (thickness) as necessary. Normally in this step the entire metallic coating is not removed but rather only a fraction thereof, which is exposed towards the surface side. Normally in this step at least the diffusion zone of the metallic coating layer remains intact.

Subsequently, a new metallic coating portion is applied onto the component to where the consumed portion of the metallic coating has been removed in a manner at least compensating for the coating removed in the previous step. New metallic coating can be applied over the entire surface areas to be coated. The application of new metallic coating is preferably tailored such that the amount of coating applied is a function of the location so as to compensate for the coating removed in the second step. The final target of this third step is to reconstitute the metallic coating layer so as to be homogeneous and intact to an extent that, for example, an optional ceramic thermal barrier coating can be applied as a top coating.

In an optional fourth step of the proposed method, the quality of the reconstituted (metallic) coating is checked. If during this step a quality defect is found, step c. can be repeated.

It should generally be noted that prior to carrying out the above method, should a ceramic coating layer be present on top of the metallic coating layer, optionally the component can be prepared by removal of this ceramic coating layer. The removal of the ceramic (thermal barrier) coating layer is normally carried out by using mechanical or chemical removal methods. One method is for example grit blasting of the component to remove the ceramic coating layer. After the removal of the ceramic coating layer, normally the component is rinsed and cleaned. If necessary, cleaning can be supplemented by a chemical cleaning treatment methods, for example by immersion into an acid bath and/or an alkaline bath.

As concerns the removal step b., this can be followed by a cleaning step (rinsing, brushing, and the like) and prior to the initiation of the deposition step c. for the new metallic layer, the exposed surface can be prepared/activated by chemical and/or mechanical methods.

According to a first preferred embodiment of the invention, in step a. the amount, and/or also the condition, and the associated location of total coated surface, or only of the locations in particular of consumed portion of the metallic coating to be replaced, is determined by using one or several non-destructive techniques, preferably selected from the group of: infrared thermography, X-ray fluorescence spectroscopy, ultrasonic or eddy current techniques, or combinations thereof. Alternatively or additionally, it is also possible to determine the amount of metallic coating to be replaced on a representative component by destructive techniques, such as, but not limited to, metallographic investigations.

According to a further preferred embodiment, in step b. the consumed portion of the metallic coating is removed by an electrolytic method comprising the steps of:

b1. immersing the component in an electrically conductive bath,

b2. electrically contacting the component and a counter electrode, in the bath,

b3. applying a potential between the component and the counter electrode, such that the component functions as an anode and the counter electrode as a cathode,

b4. controlling the potential between the anode and the cathode and measuring the current in order to monitor the coating removal or controlling the current between the anode and the cathode and measuring the voltage in order to monitor the coating removal; and

b5. stopping the coating removal of step b4. based on the monitoring of the coating removal.

Preferentially, the electrically conductive liquid bath is an aqueous acidic solution, preferably comprising HCl. Most preferred it is an aqueous hydrogen chloride solution, i.e., an aqueous solution of HCl, which contains 2-30 mass % hydrogen chloride.

Preferably at least when the potential is applied, the electrically conductive liquid bath has a temperature between room temperature and 80° C. It is further preferred that the electrically conductive liquid bath contains one or more of the following additional constituents: accelerators, inhibitors, pH buffers, anti-settling agents, anti-foaming agents, dispersants, wetting agents, surfactants, and stabilizers.

Furthermore, the electrically conductive bath can be agitated at least when the potential is applied.

According to a further embodiment, either during step b. or subsequent to step b., the amount (i.e., the thickness), and/or the condition and the associated location of the total coated surface is determined by using one or several non-destructive techniques, preferably selected from the group of: infrared thermography, X-ray fluorescence spectroscopy, ultrasonic or eddy current techniques, or combinations thereof.

According to a still further preferred embodiment of the proposed method, in step c. the new coating is applied to a thickness (identifying the consumed portion) as determined in step a. by a thermal spray technique, a gas phase deposition such as chemical or physical vapour deposition or modifications thereof, or a slurry technique, or combinations/sequences of these methods.

Preferably, the thermal spray technique is high velocity oxy fuel spraying, atmospheric plasma spraying, vacuum plasma spraying, or low vacuum plasma spraying.

Preferentially, in step d. the quality of the restored metallic coating is controlled by non-destructive techniques. These non-destructive techniques can, for example, be selected from the group of: thermography, X-ray fluorescence spectroscopy, ultrasonic or eddy current techniques, or combinations thereof. Preferably, the same method and apparatus is used as is used for step a.

As mentioned above, typically the component is a gas turbine component (blade, vane, structural parts, etc). Typically such a gas turbine component is formed of a Ni, Co, or Fe based superalloy or of a Ti based superalloy or of combinations thereof.

It is possible that the proposed method is applied in a situation where the coating consists of one or more layers which are distinguished by their chemical or physical properties, wherein preferably at least one layer of the metallic coating is of MCrAI(X) type, where M is an element selected from the group containing Ni, Co, Fe, and combinations thereof; X is an element selected from the group consisting of Y, Ta, Si, Hf, Ti, Zr, B, C, and combinations thereof; and/or wherein at least one layer of the metallic coating system is an aluminide, noble-metal-aluminide, noble metal-nickel-aluminide, or combinations thereof.

As mentioned above, it is preferred that the new coating is applied in a manner compensating for the removed consumed portion of the coating. According to a preferred embodiment this is made possible by configuring and arranging of, in step b., the geometry and/or the material of the counter electrode in such a way that metallic coating is mainly or selectively removed in the locations determined in step a. This is preferably possible by the configuring and arranging of the geometry of the counter electrode such that the distance between counter electrode and the article is larger in locations where less coating shall be removed. The size and/or the structure/surface and/or the position and/or the topology and/or the grid structure/width of the counter electrode can also be adjusted in locations where less or more coating shall be removed. It is for example possible to use a grid or web-like counter electrode which allows adapting the current density on the one hand by adaptation of the grid width and/or by adjusting the distance to the surface to be treated. Another advantage associated with the use of a grid or web-like counter electrode is the fact that it allows a much more efficient agitation of the stripping medium to achieve a fast and homogeneous stripping reaction.

In addition to or as an alternative to this method, it is possible, prior to step b., to mask the component such that the metallic coating is selectively exposed in the regions where consumed portions have to be removed during the step b., i.e., in the locations as determined in step a. Electroplater's tape, clip-on tooling, inert coatings, etc., can for example, effect such a masking.

It is not only possible to remove metallic coating by using electrolytic processes, but also to apply the new coating using galvanic deposition. Along this line, according to another embodiment of the proposed method, in step c. the new coating is applied with a thickness as determined in step a. using a galvanic deposition process. Also in this case preferably the geometry and the material (or any other property leading to locally different adapted galvanic processes) of the counter electrode is configured and arranged such that metallic coating is selectively deposited on the locations to be reconstituted. The geometry of the counter electrode can for example be configured and arranged such that the distance between the counter electrode and the article is larger on locations where less coating shall be reconstituted (galvanically deposited) and/or the size and/or the structure/surface and/or the position and/or the topology and/or the grid structure/width of the electrode is correspondingly adapted in locations where coating shall be reconstituted. It should be noted that in cases where, for the removal of the coating, an electrolytic process was already used using a specifically tailored counter electrode, that same counter electrode geometry can be used, for the deposition process, as a cathode leading to extremely homogeneous coating layers.

### BRIEF DESCRIPTION OF THE DRAWINGS

In the accompanying drawings preferred embodiments of the invention are shown in which:

FIG. 1 is a flow diagram of the steps of the proposed method;

FIG. 2 is a schematic diagram of a cross section of a coated component after operation in a gas turbine;

FIG. 3 is a cross sectional view of a coated component after operation in a gas turbine;

FIG. 4 is a cross section view of the coated gas turbine component shown in FIG. 2 after selective removal of the consumed portion of the coating;

FIG. 5 is a cross section view of the gas turbine component displayed in FIG. 4 after application of new coating; and

FIG. 6 is a cross sectional view of a micrograph of a gas turbine component with a coating on the component surface wherein the coating includes several layers and was restored as described in the present innovation in a gas turbine refurbishment.

### DETAILED DESCRIPTION OF EXEMPLARY EMBODIMENTS

Generally stated, methods embodying principles of the present invention provide a customized repair that can overcome problems inherent to the prior art and involves the following steps:

a. Identifying the portion of the coating, which is consumed as a function of location on the component. This is achieved by one or more non-destructive techniques such as, but not limited to: thermography, X-ray fluorescence spectroscopy, and ultrasonic or eddy current investigations. The integrity of the component below the coating can be verified using the same methods. Alternatively, in order to assess coating quality, representative members of one row of components can be additionally investigated by destructive techniques.

b. Removing by a process at least the consumed portions of the coating, preferably only the consumed portion. Advantageously, this can be achieved by electrolytic stripping, i.e., immersing the component in an electrolytic bath and applying a potential between the component (anode) and a cathode. The electric current (or the voltage depending on the control) changes during the stripping process depending on the amount and condition of overall coating. Consequently, the stripping can be stopped at the previously determined desired end point. If necessary, specific locations of the component can be protected by masking during the stripping process. This allows locally varying degrees of coating removal, according to a previously defined pattern for coating removal.

c. Applying a new coating, such that the thickness of the remaining coating, plus the thickness of the newly applied coating add up to the thickness distribution according to the component specific coating zone drawing.

d. Optionally quality controlling to verify if the coating restoration fulfils the requirements. The quality control is achieved by non-destructive techniques, as described in section a.

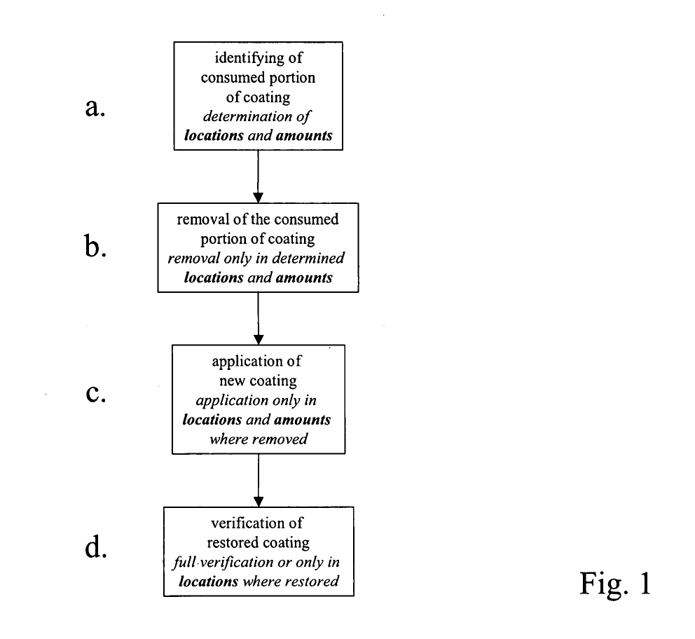

Referring to the drawings, which are for the purpose of illustrating preferred embodiments of the invention and not for the purpose of limiting the scope of the invention, FIG. 1 schematically shows the above steps in a flow diagram. In italics aspects of each step are summarised.

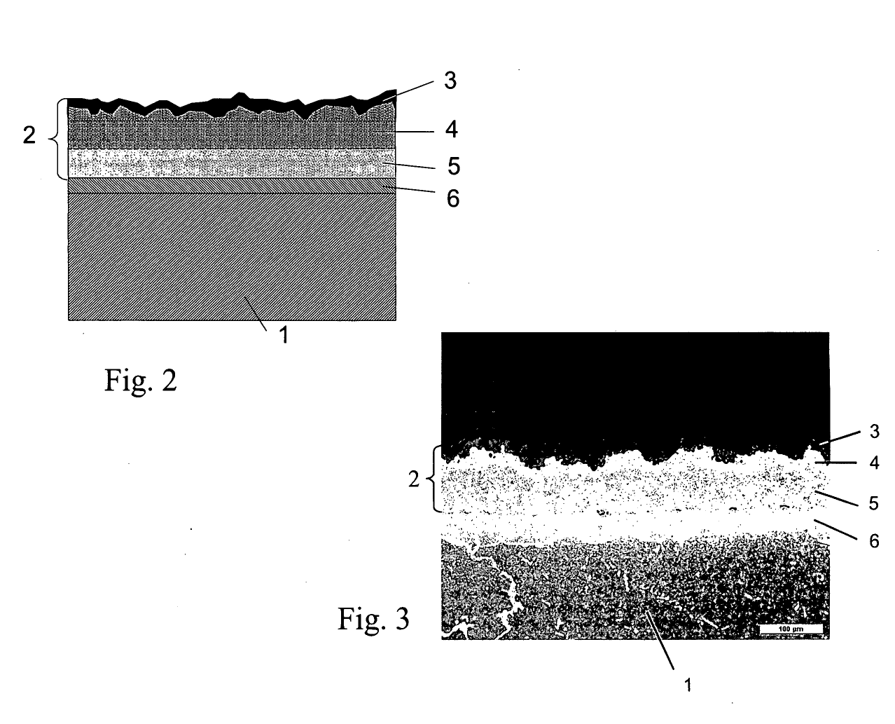

FIG. 2 shows a schematic diagram of a cross section of a coated component (1) having a coating 2 on the surface after service in a gas turbine. In the situation shown in this figure, any ceramic thermal barrier coating on top of the metallic coating 2 has already been removed by, for example, a mechanical method such as sand blasting or grit blasting, possibly supplemented by chemical methods and subsequent cleaning. The outer part 3 of the coating is oxidized and the portion below the oxidized coating is consumed 4 and requires replacement. The lower portion of the coating 5 is still in acceptable conditions and can be operated again in the gas turbine. A diffusion zone 6 is normally formed between the base material of the component 1 and the coating 2.

FIG. 3 shows a corresponding cross section micrograph of a coated component 1, having a coating 2 on the surface after service in a gas turbine. The outer part 3 of the coating is oxidized and the portion below the outer part 3 is consumed 4 and requires replacement. The lower portion of the coating 5 is still in acceptable conditions and can be operated again in the gas turbine. A diffusion zone 6 is formed between the base material of the component 1 and the coating 2.

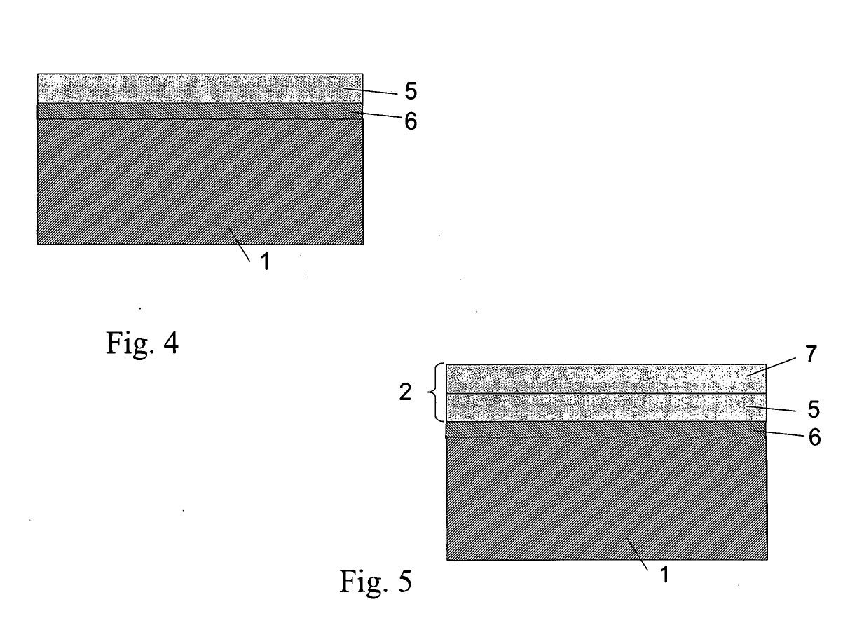

Such a component can be subjected to the proposed method using the above steps. FIGS. 4 and 5 illustrate what happens to the metallic coating during these steps.

After locating consumed portions of a coating, as shown in FIG. 2, the consumed portions of the coating are removed by immersion of the relevant parts into an electrolyte bath and by applying a cell voltage in the range of typically several thousand mV having an anodic current density in the range of 0.5-10 A/dm². The electrolyte bath is a 10-20 mass % hydrochloric acid bath at a temperature in the range of 30-50° C. The time taken for the electrolytic removal process is adapted to the amount of consumed portion of the coating to be removed. This process can, for example, be controlled by keeping the anodic current density constant over time and by monitoring the voltage. If the consumed portion of the coating is removed one can detect a change in the voltage and correspondingly stop the process at the optimum moment. Alternatively it is possible to keep the cell voltage constant and monitor the anodic current density. The anodic current density can also be monitored for pronounced changes that indicate that the consumed portion of the coating has been removed sufficiently to expose the metallic coating that is not consumed. The result is a situation as shown in FIG. 4, which is a cross section view of the coated gas turbine component 1 displayed in FIG. 3, after selective removal of the consumed portion of the coating. By this, only the portions of the coating 5 remain which are in acceptable condition. A diffusion zone 6 is formed between the base material of the component 1 and the remaining coating 5.

After this the coating layer is reconstituted wherever it had been removed, leading to a situation as shown in FIG. 5, which shows a schematic cross sectional view of the gas turbine component 1 shown in FIG. 4, after application of a new coating 7. The entire thickness of the coating 2 meets the component specific coating zone drawing. A diffusion zone 6 is located between the base material of the component 1 and the coating 2.

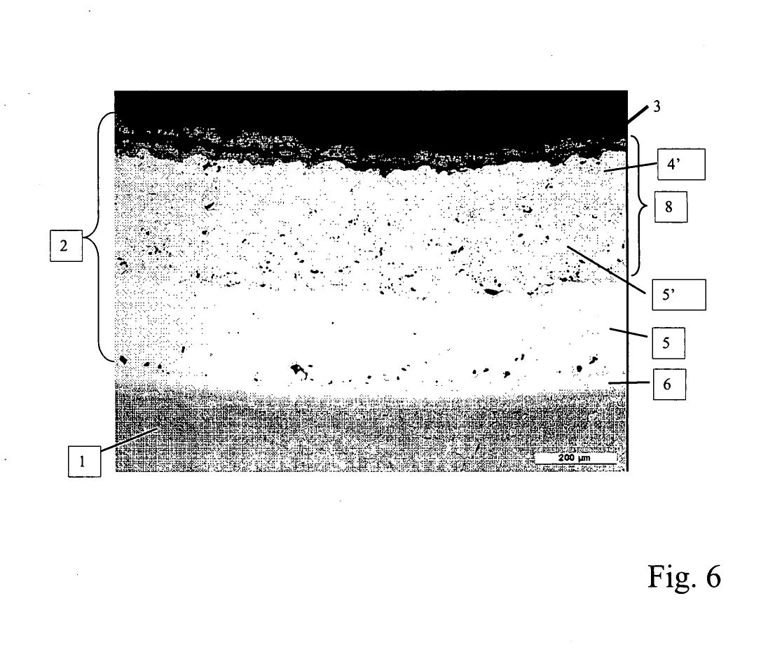

FIG. 6 finally shows a cross sectional micrograph of a gas turbine component 1 with a coating 2 on the surface of the component, in which the coating 2 includes several layers as described below. The coating 2 was restored as described herein, in a first gas turbine refurbishment. The component was again successfully operated in the gas turbine. The micrograph shows the status after completion of the second operation interval.

The inner layer 5 of the coating system 2 directly adjacent to the diffusion zone 6 on the component 1 surface is the original unrestored coating of the coating. During the restoration as described herein, a second layer 8 of coating was applied. In the second operation interval of the component in the gas turbine, the outer portion 3 of this layer was oxidized and the portion below 4′ the outer portion 3 was consumed. The inner portion 5′ of the second coating layer after service exposure 8 and the original coating 5 have protected the component during a second operation period.

### LIST OF REFERENCE NUMERALS

1 component, substrate
2 metallic coating
3 outer oxidized part of metallic coating
4 consumed part of metallic coating
5 intact part of metallic coating
6 diffusion zone of metallic coating
7 new part (layer) of metallic coating
8 second coating layer after service exposure

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method for restoration of a metallic coating of a component, wherein the coating includes a consumed portion, the method comprising:
a. identifying the consumed portion as a function of location on the component;
b. removing at least said portion identified in step a.; and
c. applying new metallic coating to at least compensate for the coating portion removed in step b., to form a restored metallic coating

2. The method according to claim 1, further comprising after c.:
d. verifying the quality of the restored metallic coating.

3. The method according to claim 1, wherein a. further comprises determining the condition of at least one of the consumed portion and the unconsumed portions of the metallic coating.

4. The method according to claim 1, wherein identifying is at least partly performed using at least one non-destructive techniques selected from the group consisting of infrared thermography, X-ray fluorescence spectroscopy, ultrasonic techniques, eddy current techniques, and combinations thereof.

5. The method according to claim 1, further comprising:
determining an amount of metallic coating to be replaced on at least one representative component by a destructive technique.

6. The method according to claim 5, wherein the destructive technique comprises a metallographic investigation.

7. The method according to claim 1, wherein removing in step b comprises removing by an electrolytic method comprising:
b1. immersing the component in an electrically conductive liquid bath;
b2. electrically contacting the component and a counter electrode, which are immersed in said bath;
b3. applying a potential between the component and said counter electrode, such that the component functions as an anode and the counter electrode as a cathode;
b4. controlling the potential between the anode and the cathode, and measuring the current in order to monitor the coating removal, or controlling the current between the anode and the cathode and measuring the voltage in order to monitor the coating removal; and
b5. stopping the coating removal based on said monitoring of the coating removal.

8. The method according to claim 7, wherein the electrically conductive liquid bath comprises an aqueous acidic solution.

9. The method according to claim 8, wherein the aqueous acidic solution comprises HCl as the main active constituent.

10. The method according to claim 9, wherein the concentration of HCl is in the rage of 2-30 mass percent.

11. The method according to claim 7, wherein at least one of:
the electrically conductive liquid bath has a temperature between room temperature and 80° C.; and
the electrically conductive liquid bath contains at least one additional constituent selected from the group consisting of accelerators, inhibitors, pH buffers, anti-settling agents, anti-foaming agents, dispersants, wetting agents, surfactants, and stabilizers.

12. The method according to claim 7, further comprising:
agitating the electrically conductive liquid bath at least while applying the electrical potential.

13. The method according to claim 7, further comprising:
subsequent to or simultaneous with step b., determining at least one of the amount, the condition, and the associated location of the total coated surface by using at least one non-destructive technique.

14. The method according to claim 13, wherein the non-destructive technique is selected from the group consisting of infrared thermography, X-ray fluorescence spectroscopy, ultrasonic techniques, eddy current techniques, and combinations thereof.

15. The method according to claim 1, wherein step c. applying new metallic coating comprises applying an amount of new coating as a function of step a. identifying said consumed portion, and wherein applying said new metallic coating comprises applying by a thermal spray technique.

16. The method according to claim 15, wherein applying by a thermal spray technique comprises applying by a technique selected from the group consisting of high velocity oxy fuel spraying, atmospheric plasma spraying, vacuum plasma spraying, low vacuum plasma spraying, chemical gas phase deposition, physical vapour deposition, a slurry technique, and combinations thereof.

17. The method according to claim 1, wherein step d. further comprises:
controlling the quality of the restored metallic coating by non-destructive techniques.

18. The method according to claim 17, wherein controlling by non-destructive techniques comprises controlling using infrared thermography, X-ray fluorescence spectroscopy, ultrasonic techniques, eddy current techniques, and combinations thereof.

19. The method according to claim 1, wherein the component comprises a gas turbine component.

20. The method according to claim 19, wherein the gas turbine component, at least at a surface region including said consumed portion, consists of a Ni—, Co—, or Fe-based superalloy, or of a Ti-based superalloy.

21. The method according to claim 1, wherein said metallic coating comprises at least one layer, wherein at least one layer of said metallic coating is of MCrAI(X) type, and wherein at least one of:
M is an element selected from the group consisting of Ni, Co, Fe, and combinations thereof;
X is an element selected from the group consisting of Y, Ta, Si, Hf, Ti, Zr, B, C, and combinations thereof; and
at least one layer of said metallic coating is selected from the group consisting of an aluminide, noble-metal-aluminide, noble metal-nickel-aluminide, and combinations thereof.

22. The method according to claim 7, wherein in step b. the geometry and the material of the counter electrode for electrolytic removal is configured and arranged to selectively remove metallic coating, wherein the geometry of the counter electrode is configured and arranged such that the distance between the counter electrode and the component is larger in locations where less coating shall be removed, and in locations where less coating shall be removed, at least one of the following characteristics of the counter electrode is adjusted: size; structure; surface; position; topology; grid structure; and grid width.

23. The method according to claim 1, further comprising at least one of:
prior to step b., masking the component such that the metallic coating is selectively exposed during step b.; and
prior to step a., removing a ceramic coating present on the surface of said metallic coating.

24. The method according to claim 23, wherein removing a ceramic coating present on the surface of said metallic coating comprises mechanically removing.

25. The method according to claim 1, wherein in step c., applying the new coating comprises applying using a galvanic deposition process and the amount of the new coating applied is a function of the identification or determination of step a.

26. The method according to claim 25, wherein the geometry and the material of the counter electrode is configured and arranged to selectively deposit metallic coating on locations to be reconstituted.

27. The method according to claim 26, wherein the geometry of the counter electrode is configured and arranged such that the distance between the counter electrode and the component is larger in locations where less coating is reconstituted, and in locations where coating is reconstituted, at least one of the following characteristics of the electrode is adjusted: size; structure; surface; position; topology; grid structure; and grid width.

28. The method according to claim 27, wherein, when removal of said coating is performed using an electrolytic process with a specifically configured and arranged counter electrode, further comprising using said counter electrode geometry for said deposition.
